(19) United States
(12) Patent Application Publication
(10) Pub. No.: US 2002/0168259 A1
(43) Pub. Date: Nov. 14, 2002

(54) Flower pot hand truck

(76) Inventor: Tyron J. McConnell, Rogersville, AL (US)

Correspondence Address: Stephen D. Carver, 2024 Arkansas Valley Drive, # 800, Little Rock, AR, 72212-4139, US

(21) Appl. No.: 09/852,859

(22) Filed: May 11, 2001

(51) Int. Cl. B60P 1/04; B62B 1/00

(52) U.S. Cl. 414/490

(57) ABSTRACT

A wheeled hand cart for transporting large flower or plant pots. A vertically upright handle has a pair of parallel sides terminating in lower frame plates. An arcuate hand grip facilitates handling. An axle extending between the plates supports wheels at opposite sides. An elongated rod extending between the plates supports a pair of forwardly projecting arms. The laterally adjustable arms emanate from rigid sleeves slidably captivated by the rod. Arm rotation is limited by an offset stabilizer. The arms pass below the stabilizer, and when the cart is parked, stabilizer-arm contact enables the cart to stand vertically. A detent plate projecting from the axle comprises an outer, serrated edge with numerous notches for cradling the cart arms when loaded. Pressure from the load borne presses the arms into the detent notches to prevent lateral displacements, so that the arms firmly grasp and bear against the load.

The closest known prior art can be seen in United States Class 414, Subclasses 444, 450, 455, 456, and 490, and Class 280, Subclasses 47.24-47.27.

### BACKGROUND OF THE INVENTION

I. Field of the Invention

The present invention relates generally to wheeled hand trucks for use in loading and unloading generally cylindrical objects. More particularly, the present invention relates to a hand truck ideally adapted and configured for transporting generally cylindrical and/or tapered structures such as flower pots and the like.

II. Description of the Prior Art

Numerous hand-operated carts and “dollies” are known in the art. Typical dollies comprising wheeled, upright frames equipped with jaws or other freight handling appendages have been used for years. The ground-engaging wheels at the bottom of the frame are captivated by a transverse axle. The weight of the load is usually shifted over the axle by the operator, who, once the load is engaged, tilts the cart over the axle by manipulating the handle. The wheel axis thus functions as a fulcrum. Usually the frame supports some form of a forwardly-projecting, mechanical surface or arm for gripping and manipulating the load to be transported. For example, the load may be supported upon a lower, forwardly projecting ledge secured to the frame, and by auxiliary structures mounted on the frame above the cart ledge. Once the load is securely engaged, and it is tipped over the axle, the wheeled frame may be manually pushed or pulled towards the load's destination.

Typical hand carts of this general description are seen in U.S. Pat. Nos. 2,510,676, and 3,084,820. The basic concept of a hand truck comprising a vertical frame disposed over a wheeled axle, with forwardly projecting arms is also seen in U.S. Pat. Nos. 2,843,280, 4,685,854, 4,735,424, 4,793,623, 3,556,548, 3,674,164, 3,503,623, and 3,499,658.

U.S. Pat. No. 5,716,183 shows an analogous hand cart that is tilted by the user over the wheeled axle. It comprises forwardly projecting structures that handle and grasp a large cylindrical item to be carried.

Hand truck U.S. Pat. No. 3,815,767 also is directed at handling large cylinders.

U.S. Pat. No. 5,315,427 shows a “cart” having two projecting arms emanating from the front for transporting flower pots.

Some loads are irregularly shaped and are difficult to handle with simple, generic hand carts. Some “regularly shaped” items, such as large cylinders, are difficult to handle because of their sheer weight. The latter problem is often aggravated by the fact that the rigid, smooth structure is not easily engaged or secured by the cart arms. Further, as in the case of large, vertically erect gas cylinders, the center of gravity may be relatively high so the workman experiences a physical challenge during lifting and transport.

Another common problem with typical hand carts is securing the load. Some prior devices include load engaging and gripping arms that extend from the cart frame. The arms are pivoted or moved relative to the cart to comfortably engage the load. Sometimes auxiliary structure is included for activating the load engaging arms. In any event it is important that the operator maintain a suitable captivating force upon the load, to prevent it from shifting in position or falling off during transport.

I have repeatedly encountered problems with prior art hand trucks or dollies when attempting to transport relatively large and heavy flower pots. The largest residential or commercial pots that are commonly available to the public are known as “16-24” pots. These clay or concrete pots are sixteen inches high, and have an upper diameter of approximately two feet. Since they are tapered, their bottom diameter is reduced. When filled with gravel, potting soil and a plant, the filled pot will often weigh between one hundred and two hundred or more pounds. It is very difficult for one person to move this much weight safely with a normal hand cart.

Another problem is that conventional flower pots are difficult to transport by hand carts because they cannot be easily-accessed by the forwardly-projecting, cart ledge or arms. For example, the bottom ledge used with most hand trucks does not reach under typical pots because of the tapered shape. Problems are especially acute when the pots are loaded with soil and a large plant, such as a tropical tree. Large exotic and tropical plants are becoming very common in conjunction with modern interior decorating schemes. Large urban and outdoor public areas are often adorned with numerous decorative and exotic trees and plants that are rooted within large flower pots. Typical terracotta or ceramic pots are relatively fragile, in that they cannot be dropped or forcibly bumped into rigid obstacles without cracking. When tilted inappropriately, dirt often spills. Where exotic plants are displayed in locations subject to wide fluctuations in temperate, or in commercial environments that are open only during specific business hours, these pots must be moved at least twice a day. A large number of such plants disposed over a relatively large display area, which may exceed one hundred thousand square feet, aggravates the task faced by the workmen. Clearly a simple and reliable cart designed especially for large pots would be in order.

With conventional dollies or hand carts it is very difficult to properly initially grasp a large, heavy flower pot. The lower, load-bearing ledge projecting from conventional carts or dollies can forcibly impact the pot and crack the fragile bottom end. When too much load is concentrated upon too small an area of the pot's bottom structure, destructive cracking often results. Since the plants may be relatively high, and the load may be relative heavy, the stability of the cart in motion is an important factor. The use of releasable, load gripping members that non-destructively captivate and stabilize the pot would be highly desirable. Yet modern hand carts or dollies tend to stress the wrong portions of the pot, and once their arms engage the load, they can bind or lock, complicating unloading.

For transporting large, heavy flower pots, a suitable hand cart should eliminate the conventional, forwardly-projecting ledge that normally bears the weight of the load. While means must be provided for quickly and non-destructively engaging the load prior to transport, these same means must be capable of quickly releasing the load at its destination, without tangling or jamming. The equipment should not require excessive operator intervention and adjustments. At all times, a suitable dolly must be safe and stable. While rigidity in construction is desirable, a lightweight, highly mobile dolly with minimum working parts would be ideal.

### SUMMARY OF THE INVENTION

My new hand cart is specifically designed to transport large, relatively heavy ceramic or concrete pots used for large flowers or plants. The cart provides a mechanical advantage to the user, and enables the pot to be moved about in a stable fashion without spilling soil or damaging the pot.

The cart preferably comprises a rigid, vertically upright handle in the form of an inverted U. The spaced-apart, and generally parallel sides of the handle terminate at their bottoms in a pair of spaced-apart frame plates shaped generally like trapezoids. A curved hand grip at the top of the handle enables manipulation of the cart. A tubular axle extends between the frame plates to support a pair of wheels at the cart sides. An elongated, metallic rod extends between the frame plates above the axle. A pair of adjustable, outwardly projecting arms are secured to rigid sleeves that are slidably captivated upon the rod. The arms are free for limited rotation about the rod, and they may be adjusted laterally from side to side as the mounting sleeves slide laterally over the rod. Arm rotation is limited, however, by an offset stabilizer that extends between the frame plates. The stabilizer is horizontally offset from the plane occupied by the axle and the rod towards the front of the cart. The arms project below the stabilizer, and when the cart is disposed vertically in a parked position, stabilizer contact with the arms, that are touching the ground at this moment, stabilizes the cart and enables it to stand vertically.

A special detent plate emanating from the axle extends between the frame plates at their bottoms. An outer, serrated edge of the detent plate projects generally towards the front of the cart. A plurality of detent notches are formed in this edge, for cradling the cart arms when a pot is to be lifted. Pressure from the load borne by the cart arms presses the arms into the detent notches to prevent lateral displacements, so that the arms firmly grasp and bear against the load.

Thus a basic object is to provide a highly efficient hand cart ideally adapted for large flower pots.

A very general object of the present invention to provide a device having the ability to lift and move objects without use of a bottom support platform.

It is also an object to provide a dolly device of the character describe that transports objects having a variety of shapes and sizes.

Another fundamental object is to provide a cart of the character described that easily handles and transports heavy, tapered, cylindrical objects.

A related object is to provide a hand cart of the character described that reliably transports heavy, cylindrical objects like large flower pots without engaging them with a lower projecting ledge.

Another object is to provide a dolly of the character described that allows the workman to walk up to the pot to be transported, and to lift and then move it without personally touching it or bending over.

A related object is to provide a dolly or hand truck that carries large pots in a vertically stable orientation, so that soil spillage is avoided.

Another important object is to provide a dolly or hand truck of the character described that easily adjusts to pots of varying diameters and sizes.

It is another object to provide a hand-operated dolly that reliably and safely retains cylindrical items for transport.

Still another object of the present invention is to provide a hand-operated dolly for lifting and transporting cumbersome objects which is relatively lightweight and highly mobile.

Another object is to allow the hand cart user to approach, contact and pick up a pot without bending over, and without personally touching the pot.

Yet another important object is to provide a dolly of the character described that is capable of moving heavy pots, and which is easily manipulated by relatively small and lightweight people.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a partially fragmentary, frontal isometric view of my new hand cart, disposed in a stable, unloaded position;

FIG. 2 is an enlarged, fragmentary isometric view showing the bottom portion of the hand cart;

FIG. 3 is a bottom perspective view of my new hand cart;

FIG. 4 is an enlarged front plan view thereof;

FIG. 5 is an enlarged, partially fragmentary view of region 5 in FIG. 4;

FIG. 6 is an enlarged, top plan view taken generally from a position above the cart, as indicated generally by line 6-6 in FIG. 4;

FIG. 7 is an enlarged, fragmentary sectional view taken along line 7-7 of FIG. 6, with portions thereof broken away for clarity or omitted for brevity, and with dashed lines indicating moved positions, obtained when the user pulls back on the handle to lift a pot;

FIG. 8 is a right side elevational view of the an unloaded cart parked next to a pot to be transported, taken generally from a position to the right of FIG. 4, with the left side elevational view comprising a mirror image;

FIG. 9 is a right side elevational view of the cart similar to FIGS. 7 and 8, but showing a captivated pot being transported by the dolly; and,

FIG. 10 is front perspective view of the preferred detent ledge.

### DETAILED DESCRIPTION

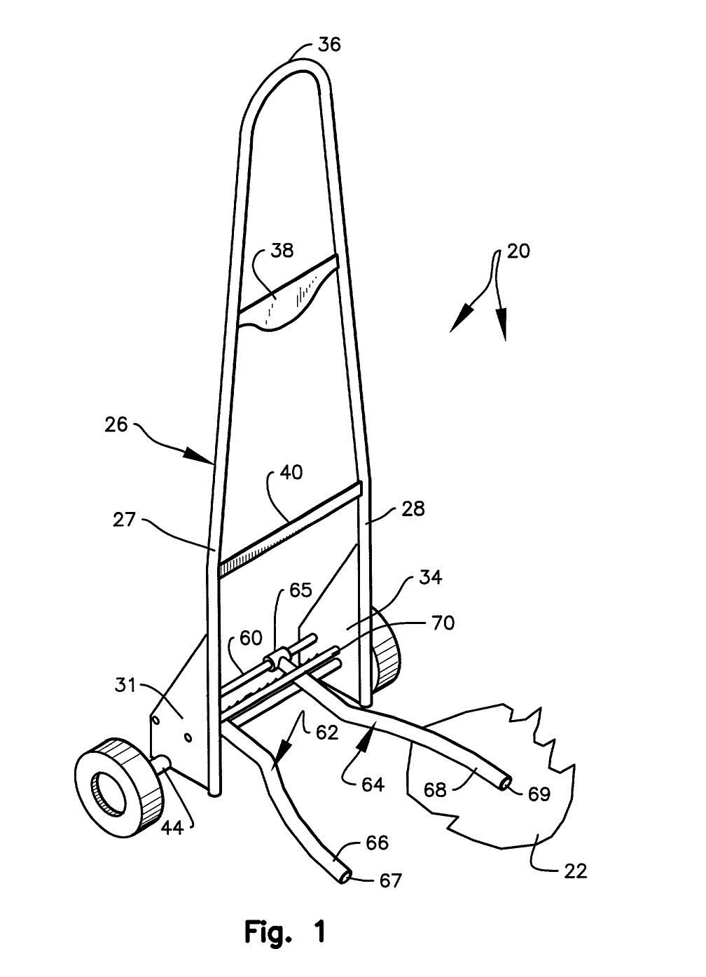

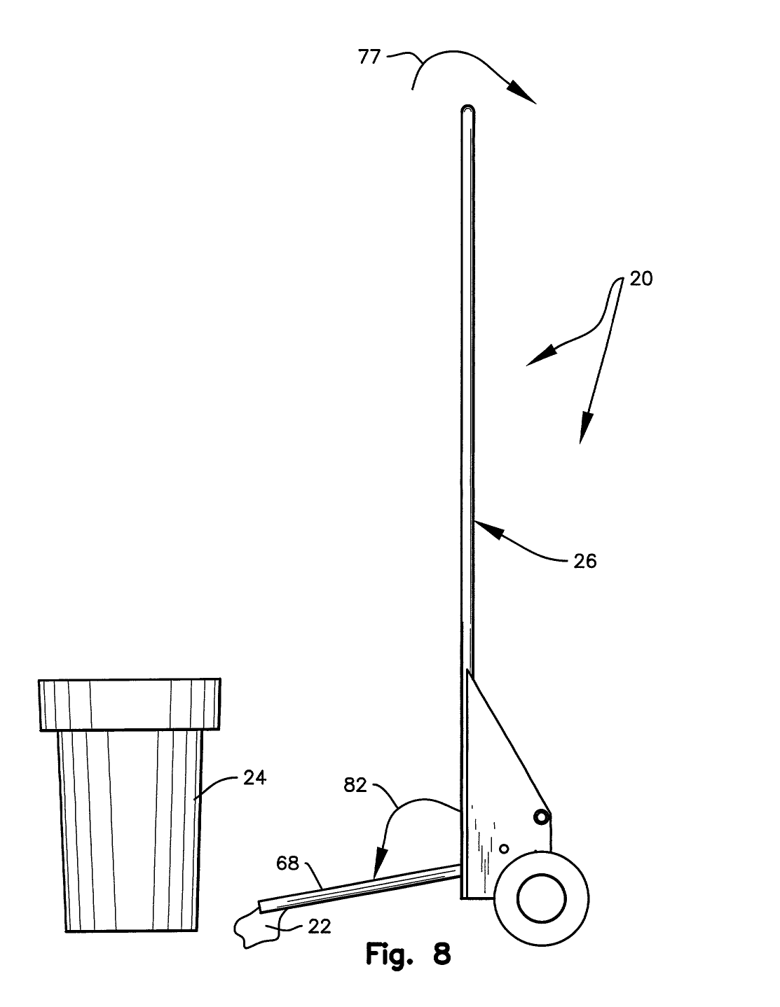

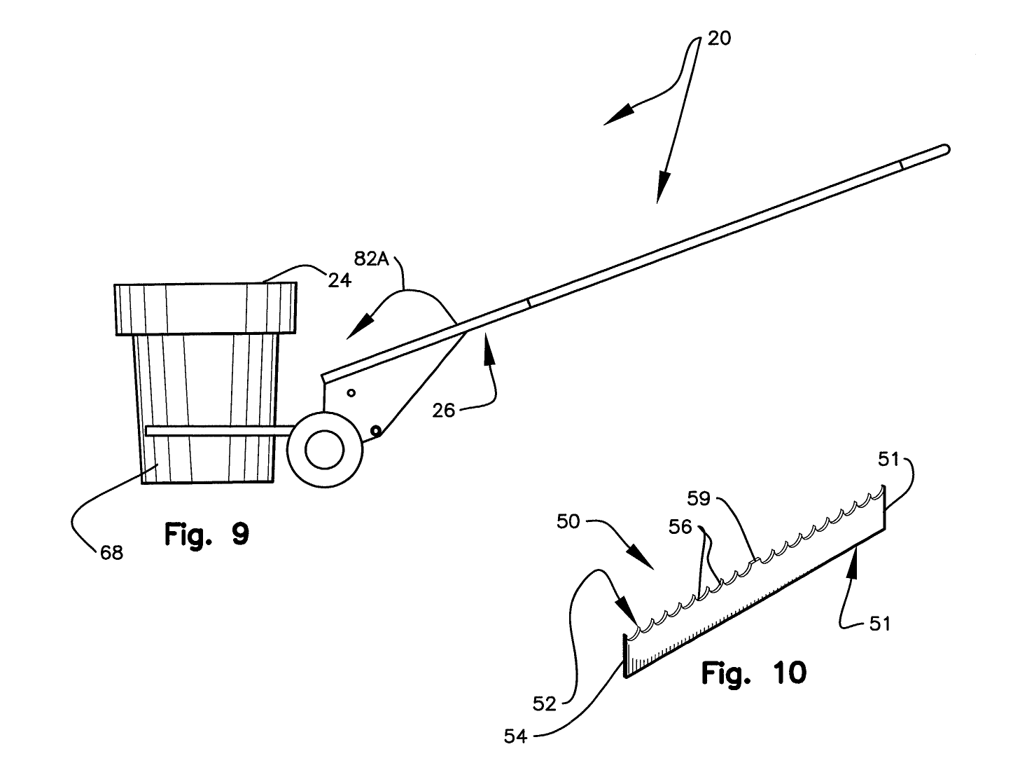

My new hand cart has been generally designated by the reference numeral 20. Cart 20 is adapted to be vertically disposed upon a flat surface 22 (FIGS. 1, 2, 5) when “parked.” As discussed hereinafter, it is used to transport ceramic or concrete pots 24 (FIGS. 8 and 9).

The preferred cart 20 comprises a rigid, elongated, handle 26 that is made of tubular steel. The generally U-shaped handle (i.e., it is shaped like an inverted U) comprises a pair of parallel and spaced-apart sides 27 and 28 that terminate at their bottoms in spaced-apart, trapezoidal frame plates 31 and 34. The top of the handle 26 preferably comprises an arcuate hand grip 36 that integrally extends between sides 27 and 28. A pair of vertically spaced-apart and parallel reinforcements 38 and 40 transversely extend between sides 27 and 28 to brace and stabilize the cart.

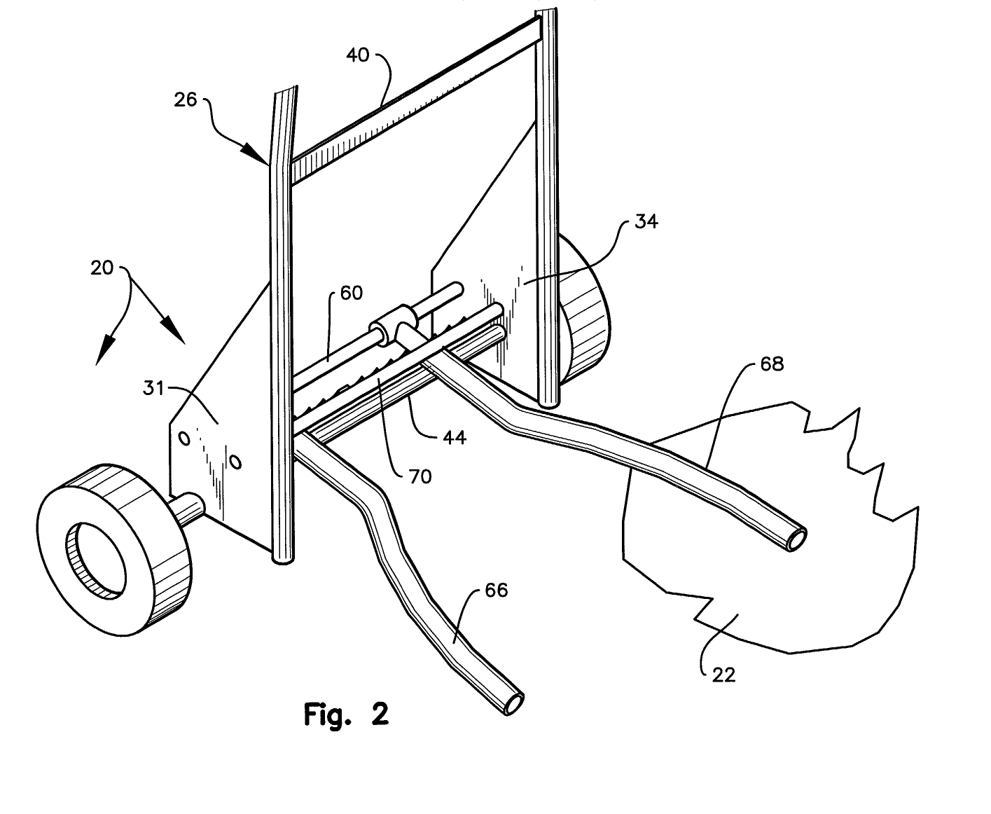

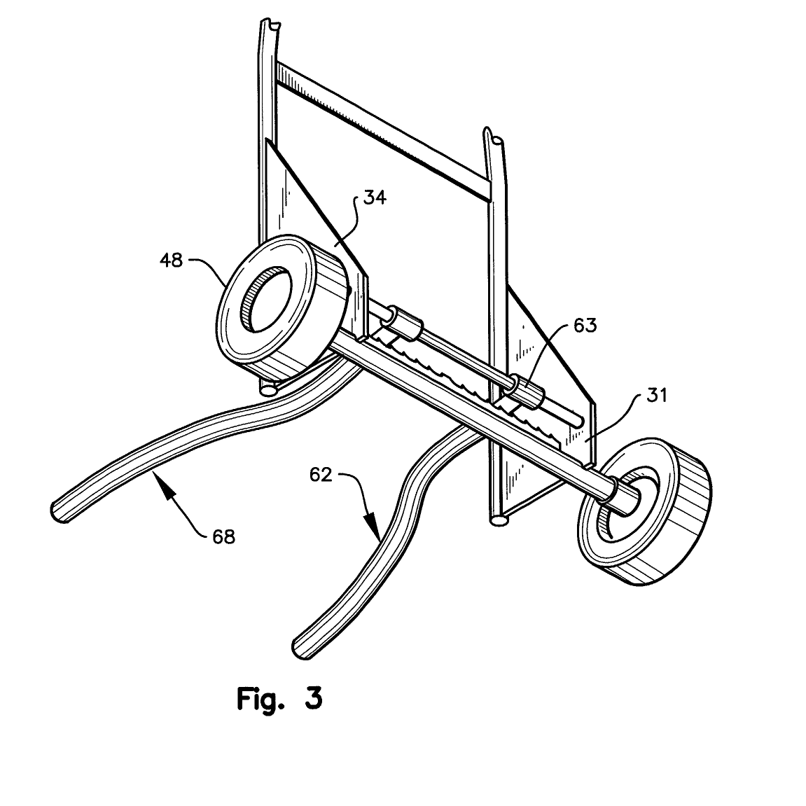

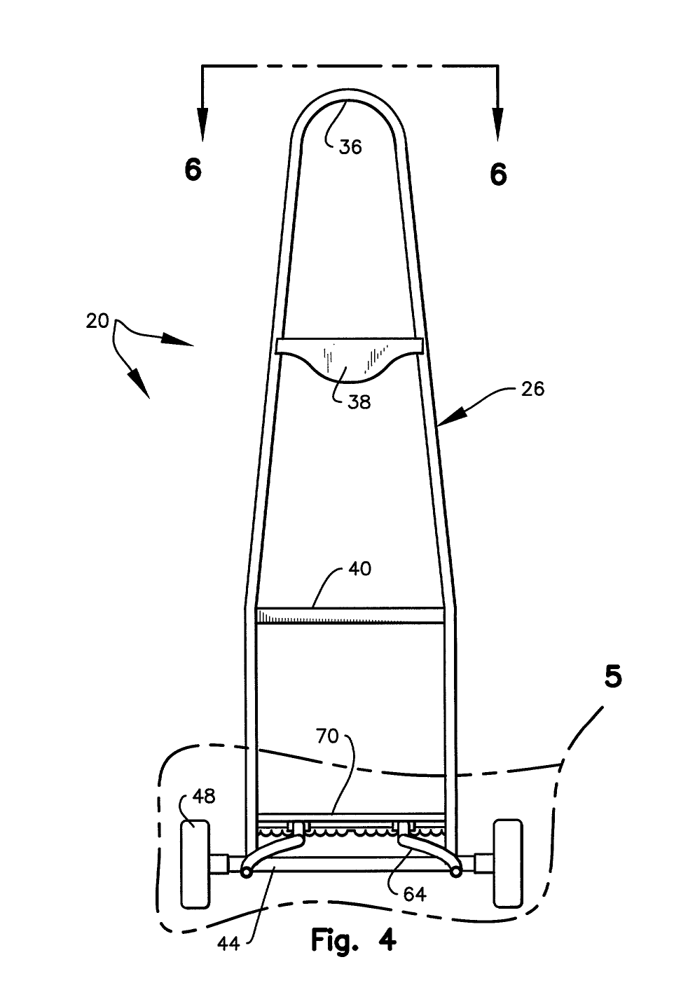

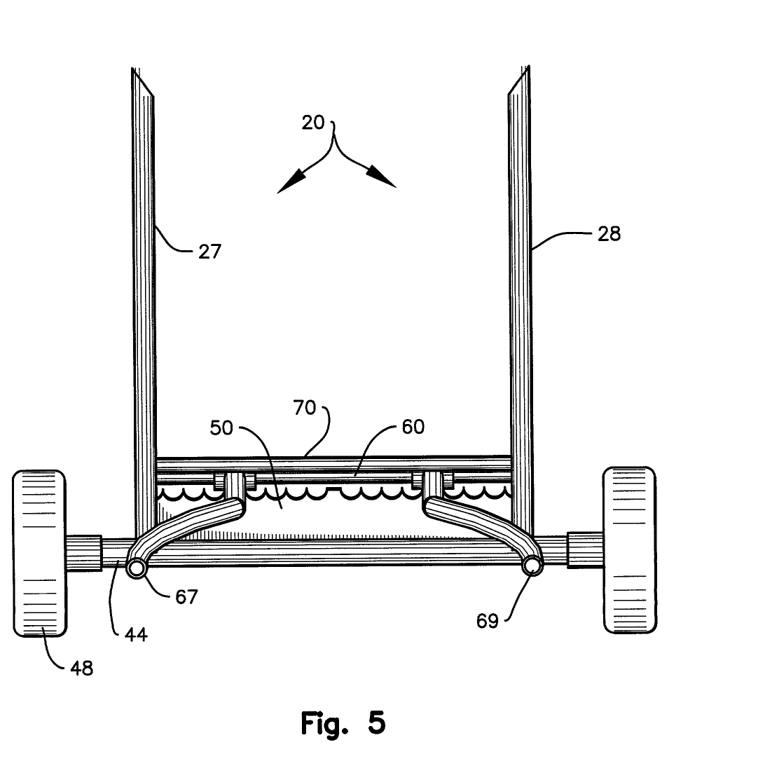

As best seen in FIGS. 2, 3, and 5-7, a tubular axle 44 extends between and through plates 31 and 34. A suitable rod (not shown) that is coaxially captivated within axle 44 is mated to bearing end caps 47 to support the wheels 48 in a conventional fashion. As best seen in FIGS. 5-7, and 10 a generally rectangular detent plate 50 has a lower edge 51 (FIG. 10) welded to axle 44. The toothed edge 52 projects away from axle 44 towards the handle 26. The ends 54, 55 contact and are welded to the lower sides of trapezoidal plates 31 and 34. A plurality of detent notches 56 are defined in edge 52 for engaging and cradling the cart arms when the cart is loaded, as will be described later. A flat central portion 59 forms the middle of the detent plate 50.

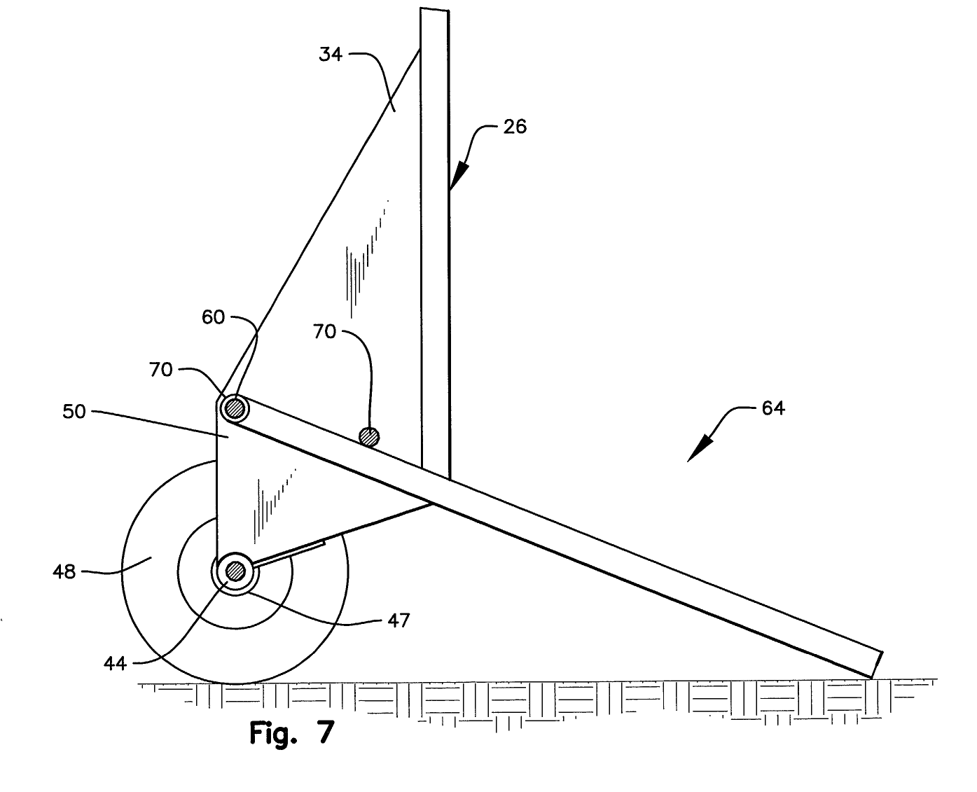

As best seen in FIGS. 2 and 7, there is a rigid slide rod 60 located above horizontal axle 44 that rigidly extends between plates 31 and 34. Preferably, transverse slide rod 60 is parallel with and vertically spaced above axle 44. When the cart 20 is disposed in the “parked” position of FIG. 1, the plane occupied by rod 60 and axle 44 is substantially perpendicular to the supporting surface 22 (FIG. 1). Slide rod 60 supports the arms 62, 64 that project forwardly from the cart.

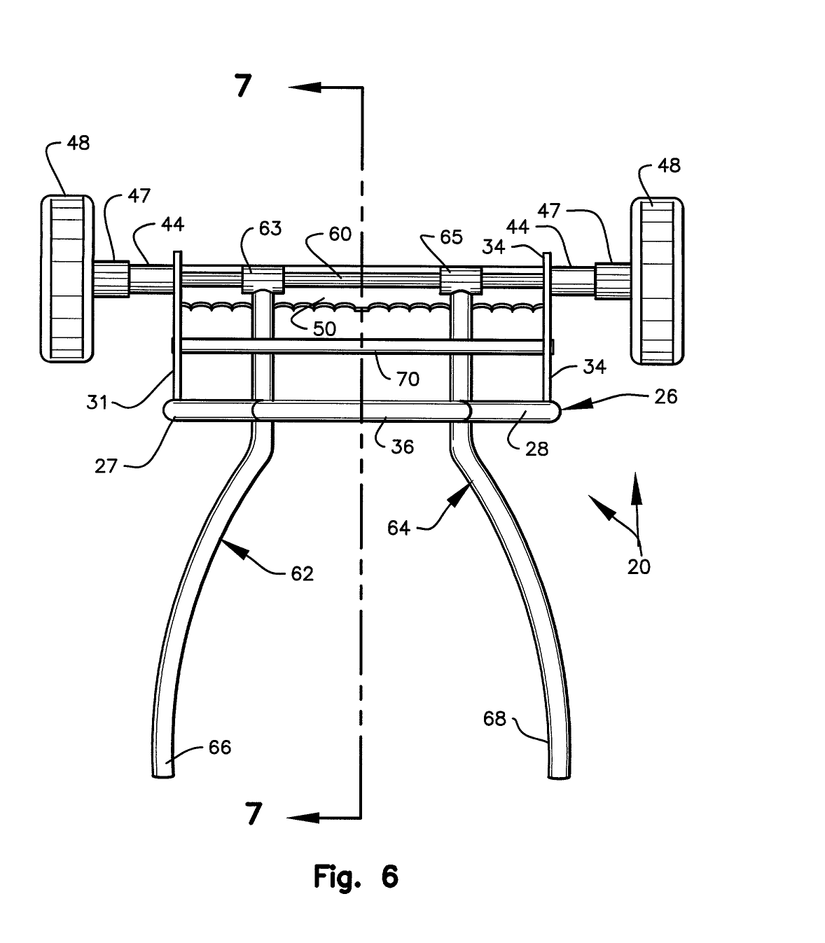

Each arm 62, 64 has an inner portion welded to a tubular sleeve 63, 65 respectively (FIG. 6) that is slidably captivated upon rod 60. Each sleeve 63, 65 is free to slide laterally over rod 60, and each sleeve can rotate about rod 60 as well. The arms 62 and 64 may thus be moved laterally and up and down, as they are free for limited rotation about rod 60 as well. Each arm 62, 64 is preferably covered with a resilient, tubular covering 66, 68 made of Tygon™ brand tubing. This prevents marring or scratching of items carried by the cat. The ends 67, 69 of metal arms 62, 64 are visible in FIG. 1. The arms are curved or arcuate to fit the profile of cylindrical items they contact. The preferred arcuate profile of the curved arms enables the arms to nest up against the cylindrical surfaces of pots or other objects to be moved. In other words, in the best mode, each arm is curved to flushly abut the curved profile of the pots to be moved. The sleeves 63 and 65 are slidable along the length of the rod 60, so that the spacing between the arms 62, 64 may be varied, depending, for example, upon the diameter of the pot to be captivated and transported.

Thus spaced between the open arms 62 and 64 may be widened or narrowed by sliding the arms along the rod 60. As described later, during deployment and movement of the cart, the arms will rest within appropriate notches 56 in the detent plate 50. As the weight of the captivated pot will press them downwardly into the detent plate, they will firmly maintain their grasp upon the pot or other cylindrical item being transported, as lateral displacements of the loaded arms will be firmly resisted by contact within the detent notches.

Preferably a rod-like stabilizer 70 is horizontally spaced-apart from axle 44 and rod 60. Stabilizer 70 (FIGS. 2, 6) in effect limits rotation. As best seen in FIGS. 2 and 6, stabilizer 70 extends between plates 31 and 34, to which it is rigidly welded. Stabilizer 70 is parallel with and spaced-apart from axle 44 and rod 60. By viewing FIG. 6 it will be appreciated that stabilizer 70 is horizontally offset from both axle 44 and rod 60 towards the front of the cart. Thus stabilizer 70 is horizontally offset from the plane co-occupied by both the axle and the slide rod. Even more offset is the handle 26, which, in FIG. 6 especially, can be seen to occupy a plane at the front of the cart that is spaced-apart from both the axle 44, slide rod 60, and stabilizer 70. In FIG. 7 it will be appreciated that the stabilizer 70 is also vertically downwardly offset from slide rod 60, being positioned vertically below rod 60, but vertically above axle 44. Rod 70 is disposed between the plane established by the axle and slide rod, and the plane established by the handle 26.

Arms 62 and 64 project away from rod 60 below stabilizer 70 (FIGS. 2, 6). As these arms are generally free to rotate about rod 60 (i.e., because of slidable sleeves 63, 65), they are yieldably deflected upwardly into contact with stabilizer 70 when the cart is parked (FIGS. 1, 2). Since the handle 26 is spaced-apart and offset from the wheeled axle 44, it tends to rotate (i.e., tip over) in a clockwise direction relative to axle 44. As it does so, arms 62, 64 contact the ground 22 (i.e., or other supporting surface), and as the cart rotatably moves, rod 70 is rotated about the axis of rotation established by axle 44 into a position contacting the arms, stopping further cart rotation. The latter position is assumed when the device is parked, as in FIG. 1. The same form of stabilization occurs when a loaded cart is parked; although the arm tips do not contact ground (i.e., the pot between the arms would contact ground), the handle can be supported in effect by stabilizer contact with the arms when the cart is released.

### OPERATION

When the device is to be used, the operator manipulates handle 26, presumably grasping the hand grip 36. Assuming that the cart had been parked (as in FIGS. 1, 8), the handle would be rotated over the axle 44 by pulling it into the direction of arrow 77 (FIGS. 7, 8). While “parked” upon ground 22 the arms 62, 64 form an obtuse angle 82 (FIG. 8) relative to the handle 26. As the handle is pulled over the wheeled axle in the direction of arrow 77, stabilizer 70 will be rotated out of contact with arms 62, 64. As further rotation or tilting occurs, the arms 62, 64 will be lifted out of contact with the ground by subsequent contact with the detent plate 50. The detent plate middle portion 59 aids in centering, by tending to maintain the sleeves 63, 65 on one side of the detent plate or the other. The cart may then be moved towards a pot 24 to be moved.

When disposed adjacent a pot 24, the cart arms 62, 64 are gently lifted and spread apart by sliding the sleeves discussed earlier. At this time, the cart may be pushed towards the pot, with the arms disposed upon either side. Once the pot is circumscribed, with the arms pushed forward after being spaced-apart, the arms are gently lifted, and compressed towards each other. By sliding them towards the center of the cart, they will assume a working diameter that will firmly grasp the pot. Once the handle is again tilted, the arms will be rotated upwardly, contacting a larger diameter of the pot, and firmly grasping it. At the same time, the arms will rest in the various cradle-like notches 56 in the detent 50, so lateral displacements of the arms are avoided. The weight of the pt borne by the arms firmly urges them into the detent, and sideways movements are resisted. During pot transportation, the cart will assume n orientation similar to that illustrated in FIG. 9, depending upon the size and configuration of the pot involved. The angle 82A (FIG. 9) will have increased from the former angle 82 (FIG. 8) assumed in the rest position. As the handle assume a position tilted towards the right (i.e., as viewed in FIGS. 8, 9) the leverage provides the user with a mechanical advantage that, in effect, lightens the load. Moreover, as the handle assumes the latter position, vector displacements inputted by the user when he or she pushes or pulls the load resolve into horizontal forces that easily displace the entire load.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims

As many possible embodiments may be made of the invention without departing from the scope thereof, it is to be understood that all matter herein set forth or shown in the accompanying drawings is to be interpreted as illustrative and not in a limiting sense.

What is claimed is:

1. A hand cart for transporting large, generally cylindrical objects like flower or plant pots, the cart comprising:
a front;
a rigid, vertically upright handle comprising a pair of parallel, spaced-apart sides;
an axle extending between the frame sides;
wheels at opposite sides of the cart secured by said axle;
an elongated slide rod extending between the frame sides;
a pair of laterally adjustable arms emanating from said slide rod and projecting towards said front for selectively grasping a pot or other object to be moved or transported, each arm comprising a sleeve that is slidably captivated upon said rod; and,
a rigid detent plate for preventing lateral movements of the arms when the cart is loaded.

2. The hand cart as defined in claim 1 further comprising a rigid stabilizer extending between the handle sides.

3. The hand cart as defined in claim 1 wherein the detent plate comprises a plurality of notches for cradling the cart arms.

4. The hand cart as defined in claim 3 wherein the detent plate adjoins the axle and projects towards said cart front.

5. The hand cart as defined in claim 2 wherein the axle and the slide rod are coplanar, and the stabilizer occupies a plane that is horizontally offset from said plane occupied by said rod and said axle towards the front of the cart.

6. The hand cart as defined in claim 1 wherein the axle and the slide rod are coplanar, and the handle occupies a plane that is horizontally offset from the plane occupied by said rod and said axle towards the front of the cart.

7. The hand cart as defined in claim 6 further comprising a rigid stabilizer between the handle and the plane occupied by said axle and rod, and wherein the arms project beneath said stabilizer.

8. The hand cart as defined in claim 7 wherein the detent plate comprises a plurality of notches for cradling the cart arms and it projects towards said front from said axle.

9. A hand cart for transporting large, generally cylindrical objects like flower or plant pots, the cart comprising:
a front;
rigid, vertically upright handle for enabling manipulation of the cart, the handle comprising a pair of parallel, spaced-apart sides;
a pair of rigid, lower, spaced-apart frame plates supported by the frame sides;
an axle extending between the frame plates;
wheels connected to said axle enabling cart locomotion;
an elongated slide rod extending between the plates above the axle;
a pair of laterally adjustable arms emanating from said slide rod and projecting towards said front for selectively grasping a pot or other object to be moved or transported, each arm slidably supported by said rod; and,
means for preventing lateral displacements of the arms when said cart is loaded.

10. The hand cart as defined in claim 9 wherein said means for preventing lateral displacements of the arms when said cart is loaded comprises a detent plate comprising a plurality of notches for cradling the cart arms.

11. The hand cart as defined in claim 10 further comprising a rigid stabilizer extending between the plates.

12. The hand cart as defined in claim 11 wherein the arms extend beneath the stabilizer.

13. The hand cart as defined in claim 11 herein the axle and the slide rod occupy a plane that is oriented substantially perpendicularly relative to ground when the cart is parked in a rest position.

14. The hand cart as defined in claim 13 and the stabilizer is horizontally offset from the plane occupied by said slide rod and said axle towards the front of the cart.

15. The hand cart as defined in claim 14 wherein the handle occupies a plane that is horizontally offset from said plane occupied by slide said rod and said axle towards the front of said cart.

16. The hand cart as defined in claim 15 wherein the stabilizer is disposed between said handle and the plane occupied by the axle and slide rod.

17. A hand cart for transporting large, generally cylindrical objects like flower or plant pots, the cart comprising:
a front;
a rigid, vertically upright handle comprising a pair of parallel, spaced-apart sides;
a pair of rigid, lower, spaced-apart frame plates;
an axle extending between the frame plates;
wheels disposed at opposite sides of the cart and attached to said axle;
an elongated slide rod extending between the frame plates above said axle;
a pair of spaced-apart sleeves slidably captivated upon said slide rod;
a pair laterally adjustable, arcuate arms projecting towards said front, each arm emanating from a sleeve for selectively grasping a pot or other object to be moved or transported; and,
a rigid, forwardly projecting detent plate contacted by said arms for preventing the arms from laterally moving when the cart is loaded.

18. The hand cart as defined in claim 17 wherein said handle occupies a first plane, the axle and the slide rod occupy a second plane, and said first plane is horizontally offset from said second plane towards the front of said cart.

19. The hand cart as defined in claim 18 further comprising a rigid stabilizer extending between the fame plates and disposed between said first and second planes.

20. The hand cart as defined in claim 19 wherein said arms project beneath the stabilizer.

21. The hand cart as defined in claim 20 wherein said detent plate comprises a plurality of notches for receiving the cart arms.

22. A hand cart for transporting large, generally cylindrical objects like flower or plant pots, the cart comprising:
a front;
a rigid, vertically upright handle for moving the cart, the handle comprising a pair of parallel, spaced-apart sides occupying a first plane;
a pair of rigid, lower, spaced-apart frame plates;
an axle extending between the frame plates;
wheels disposed at opposite sides of the cart and attached to said axle;
an elongated slide rod extending between the frame plates above said axle, said rod and said axle occupying a second plane;
a pair of spaced-apart sleeves slidably captivated upon said slide rod;
a pair laterally adjustable arms projecting towards said front, each arm emanating from a sleeve for selectively grasping a pot or other object to be moved or transported;
a rigid, forwardly projecting detent plate contacted by said arms when the cart is loaded, the detent plate comprising a plurality of notches for receiving the cart arms and for preventing the arms from laterally moving; and,
wherein first plane is horizontally offset from said second plane towards the front of said cart.

23. The hand cart as defined in claim 22 wherein the stabilizer is disposed between said first and second planes.
